(19) United States
(12) Patent Application Publication
(10) Pub. No.: US 2021/0387801 A1
(43) Pub. Date: Dec. 16, 2021

(54) TRASH RECEPTACLE WITH SNAP LID CLOSURE

(71) Applicant: Valet Living, LLC, Tampa, FL (US)

(72) Inventors: Thomas M. FITZGERALD, Naples, FL (US); David D. McCLANAHAN, Hatleysvile, PA (US); Kelly VEATCH, Mt. Pleasant, SC (US)

(21) Appl. No.: 17/336,733

(22) Filed: Jun. 2, 2021

Related U.S. Application Data
(60) Provisional application No. 63/037,107, filed on Jun. 10, 2020.

(51) Int. Cl. B65F 1/16; B65F 1/06

(52) U.S. Cl. CPC B65F 1/1615; B65F 2250/114; B65F 1/068

(57) ABSTRACT

The invention relates to a lid mechanism, such as those for trash containers and more particularly to a lid mechanism which is operable with only one hand.

### CROSS-REFERENCE TO RELATED APPLICATION

This application claims priority from U.S. Provisional Patent application 63/037,107 filed on Jun. 10, 2020, which is hereby incorporated by reference herein for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention and the applicants make no claim to any trademarks referenced.

### BACKGROUND OF THE INVENTION

### 1) Field of the Invention

The invention relates to the field of lid mechanisms, such as those for trash containers, and, more particularly to a lid mechanism which is operable with only one hand.

### 2) Description of Related Art

Currently the state of the art includes receptacles and other devices having lids or doors used in a variety of different settings. For example, in both residential and commercial settings, trash receptacles and other devices often have lids or doors for protecting or preventing the escape of the contents of the receptacle. In the context of trash receptacles, some trash receptacles include lids or doors to prevent odors from escaping and to hide the trash within the receptacle from view. Additionally, the lid of a trash receptacle helps prevent contamination from escaping from the receptacle.

Currently, the prior art shows trash receptacle lids that are primarily designed to fit over a feature in the lower can portion of the receptacle which is normally configured as a flange and the entire lid is secured to the flange. An alternative method is for the lid to have a mechanically operated opening means, which also creates a latching means for the lid. However, these solutions do not lend themselves to a single hand operation and they also do not provide a means of insuring that the lid is secure and properly closed to protect or prevent the escape of the contents of the receptacle.

Therefore, what is needed in the art is a trash receptacle lid which is capable of being open and closed with a single hand and which has a single latching device, which can be operated with a single hand while opening the trash receptacle lid.

### BRIEF SUMMARY OF THE INVENTION

The invention in one form is directed to a trash receptacle lid with a first part of a latching mechanism which is molded into the lid and the second part of the latch which is molded to the lower receptacle lip, and the first and second part of the latch result in an interference fit with the mating first and second part of the latch. The latch is opened by overcoming the interference, which is overcome by manipulating the first part of the latching mechanism on the trash receptacle lid, which can be done with a single hand, thereby leaving the second hand free to remove a bag with the contents of the trash receptacle, without having to use the other hand.

Another advantage of the trash receptacle is that the device can be emptied by lifting a plastic liner out of the trash container using one hand while lifting the hinged cover with the other hand.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is an isometric view of the trash receptacle of the invention with lid closed;

FIG. 2 is a left side view of the trash receptacle of the invention with lid closed;

FIG. 3 is a front plan view of the trash receptacle of the invention with lid open;

FIG. 4 is a cross sectional view of trash receptacle of the invention with lid closed;

FIG. 5 is a cross sectional view of trash receptacle of the invention with lid open;

FIG. 6 is an isometric view of the lid from the underside;

FIG. 7 is a sectional view showing the latch, lid and can rim;

FIG. 8 shows an isometric view of the lid from the underside; and

FIG. 9 shows a sectional view of the latch.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms trash container, trash receptacle, trash can and trash bin are used interchangeably to mean a device for storing waste material.

The terms person, people, individual and employee are used interchangeably to mean a person who is opening the trash bin.

The term trash container lid, lid, cover and top are used interchangeably to mean a cover for a trash container.

The term latch as used in the specification is meant to mean a device to prevent the trash container lid from accidental opening or being opened by animals or children.

The prior art does not provide for a system that allows a person to unlatch the lid with one hand thereby facilitating the removal of the bag containing the trash with the free hand.

The amount and collection of trash is an ever-growing problem. This is especially true in consumer sectors where a large amount of refuse is discarded daily. Most consumers have trash receptacles adjacent to their homes for collecting trash generated in or around the home. The contents of the trash bins may be collected or disposed of on a regular basis, for example by curb side pickup. However, the need to have an easy-to-use lid with a closure device is evident when considering the placement of trash into the trash receptacle and during the removal of trash from the trash receptacle.

The trash collection device of the instant invention provides a receptacle for holding trash. The trash receptacle is formed from the following components: a lid hinged to the body of the trash receptacle, and a flexible latch positioned at the approximate center of the lid which can engage with the lower trash receptacle mating latch piece, which is positioned on the lower trash receptacle rim.

The lid and latch system of the trash receptacle comprise of a trash receptacle having a lower container, a lid which is hinged to the lower container and the lid having a first part of a latching mechanism which is moveably in communication with a second part of the latch which is molded to the lower container lip. The first and second part of the latch result in an interference fit with the mating first and second part of the latch when the latch is in the closed position. The latch is opened by manipulating the first part of the latching mechanism on the trash receptacle lid thereby overcoming the interference between the first part of a latching mechanism and the second part of the latch mechanism. The instant invention allows the lid to be opened with a single hand, thereby leaving the second hand free to remove trash and/or a bag with the contents of the trash receptacle, without having to use the other hand.

While this invention is described with a preferred embodiment shown in the drawings, and will be described herein in detail, specific embodiments thereof with the understanding that the present disclosure is to be considered as an exemplification of the principles of the invention and is not intended to limit the invention to the specific embodiments illustrated.

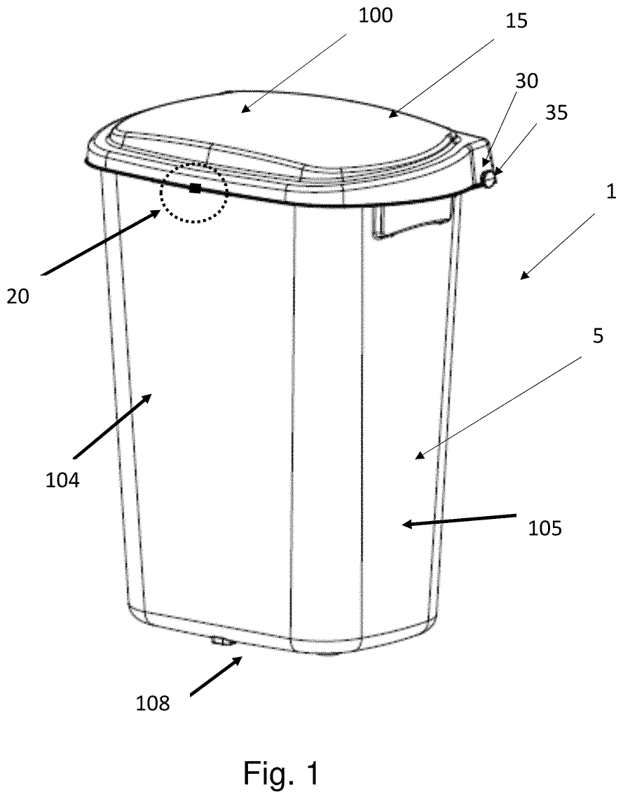

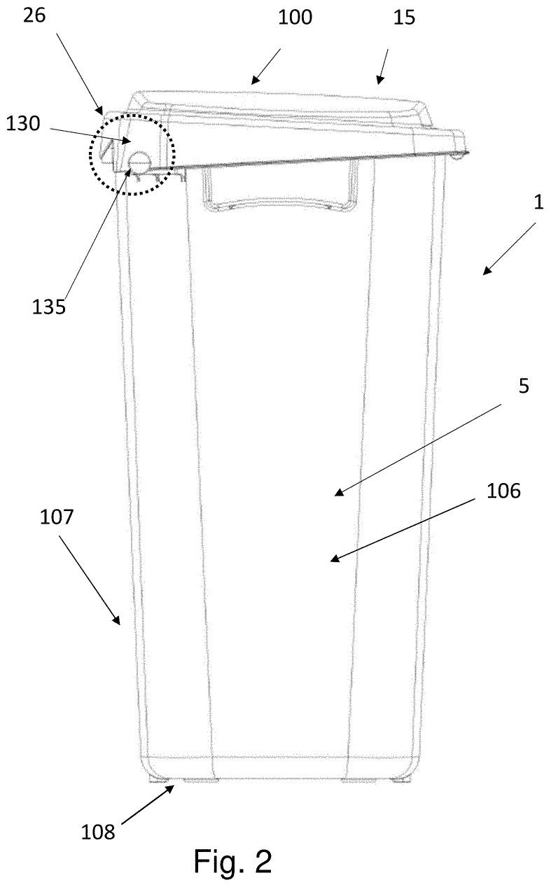

Referring to FIG. 1-9 and more specifically to FIGS. 1, 2, 4, 5 and 9, the trash receptacle 1 of the instant invention comprises of a lower container 5, a lid 15 and a latch 20. The lid 15 having a top surface 100 and a bottom surface 101 and the lower container 5 having a lower container opening 102, a bottom 108, a front 104, a back 107, a right side 105 and a left side 106.

The lower container opening 102 being at the proximal end of the lower container 5 and bottom 108 being distal from the lower container opening 102. The lower container having a lip/rim 10 and the lip/rim 10 forming the lower container opening 102 of the lower container 5.

The lower container right side 105 has a right pin 35 which is mounted to the lower container right side 105 proximal to the back of the lower container 5. The pin 35 can be a molded part or a separate part mounted to the lower container 5.

The lower container left side 106 has a left pin 135 which is mounted to the lower container left side 106 and is proximal to the back 107 of the lower container 5. The pin 135 can be a molded part of the lower container 5 or a separate part mounted to the lower container 5.

The lid 15 is rotatably mounted to the lower container 5 with a right padeye 30 which is attached to the right pin 35 and with a left padeye 130 which is attached to the left pin 135 such that the lid bottom 101 is proximal to the lower container lip/rim 10. Padeye 30 and padeye 130 can be either a partial circle or 360-degree hole. When padeye 30 and padeye 130 are formed in the shape of a partial circle, they are preferably between 270 and 330 degrees.

The latch 20 has a first latch part 140 mounted to the lid bottom surface 101 and it is distal from the right padeye 30 and the left padeye 130 of the lid 15. The latch 20 has a second latch part 141 mounted to the lower container lip/rim 10 and distal from the right pin 35 and the left pin 135. The second latch part 141 can also be the lip/rim 10 or a reinforced lip/rim 10 that can mate with the first latch part 140. The first latch part 140 and said second latch part 141 are aligned. The first latch part 140 is flexibly mounted to the lid 15 bottom surface 101. The first latch part 140 can be an integral plastic hinge or other flexible device such as a hinge, link or flexible member.

The first latch part 140 and the second latch part 141 are designed such that when the lid 15 is closed the first latch part 140 and the second latch part 141 are in communication with each other so as to form an interference between the first latch part 140 and the second latch part 141 and the interference between the first latch part 140 and the second latch part 141 results in the lid 15 being securely locked to the lower container 5. The latch 20 is opened by applying force to the first latch part 140 which moves the first latch part 140 so that the first latch part 140 and the second latch part 141 do not have interference which allows the lid 15 to rotate about the right pin 35 and the left pin 135. The rotation allows the lid 15 to open and expose the lower container opening 102. The person applying force to the first latch part 140 causes the first latch part 140 to move freeing the lid 15 from the second latch part 141 which allows a person to open the trash receptacle 1 with one hand. The preferred motion is for the first latch part 140 to move away from the front 104 of the lower container 5. Alternatively, the first latch part 140 could be constructed to move either left or right from the second latch part 141.

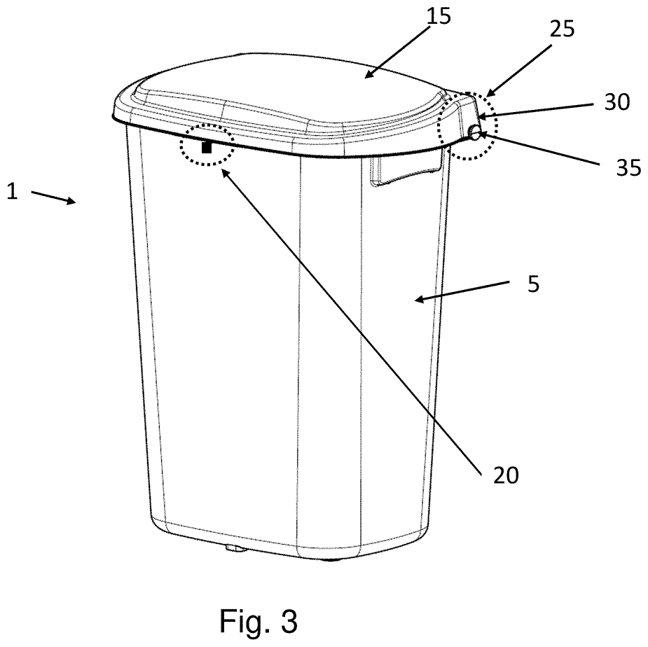

Referring to FIG. 3 there is shown an isometric view of the trash receptacle 1 of the invention with lid closed. The latch 20 is comprised of first latch part 140 and said second latch part 141. The trash receptacle 1 is comprised of can 5 having lip/rim 10 and a lid 15 with second latch part 141. Lid 15 is rotatably mounted to can 5 by trunnion 25 comprising of right padeye 30 which is part of lid 15 and right pin 35 and trunnion 26 comprising of left padeye 130 which is part of lid 15 and left pin 135 which is part of can 5. The latch 20, can 5 and lid 15 are made from a fire-retardant plastic or thermoplastic material such as polyethylene with various additives to improve the fire retarding properties of the polyethylene. However, the latch 20 first latch part 140 and the second latch part 141 can be made from any suitable material.

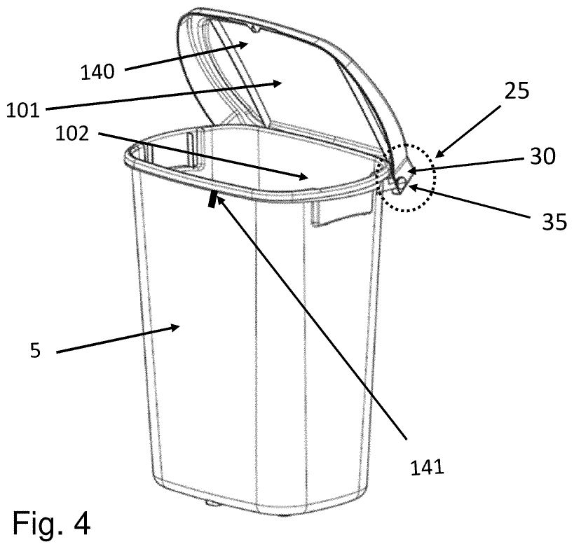

Referring to FIG. 4, there is shown an isometric view of the trash receptacle 1 of the invention with lid open. The trash receptacle 1 is comprised of can 5 having lip/rim 10 having second latch part 141 and a lid 15 with first latch part 140. Lid 15 is rotatably mounted to can 5 by trunnion 25 comprising of right padeye 30 part of lid 15 and right pin 35 part of can 5 and by trunnion 26 comprising of left pin 135 part of can 5 and left padeye 130 part of lid 15. The lid 15 first latch part 140 is engaged with the second latch part 141. The second latch part 141 as envisioned by the instant invention can be formed in multiple ways including but not limited to a separate piece to reinforce rim 10 of can 5, the rim 10 of can 5 without the reinforcement separate piece, or a separate part attached to the rim 10. The instant invention envisions the second latch part 141 to be a reinforcement of lip/rim 10 or the lip/rim 10 without reinforcement.

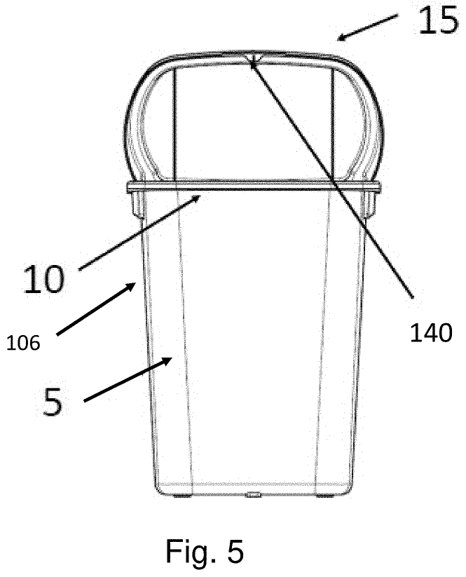

Referring to FIG. 5, there is shown a front view of the trash receptacle 1 of the invention with lid open. Latch 20 first latch part 140 is shown located on the underside and on the proximal edge of lid 15 and located approximately halfway between the left and right sides of lid 15.

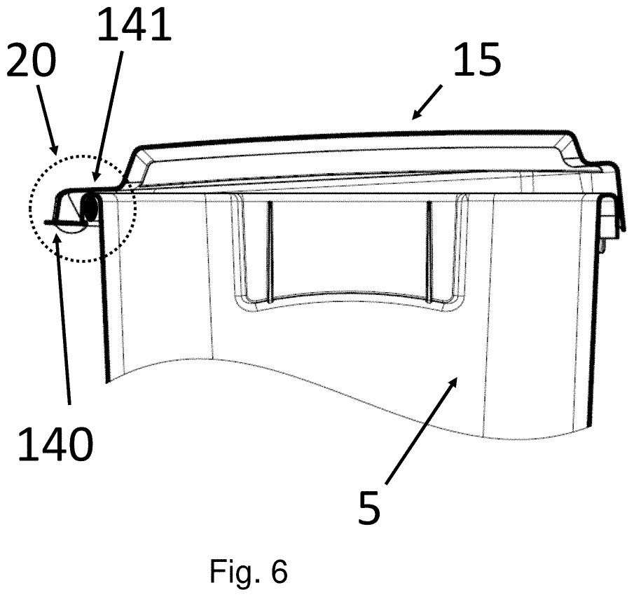

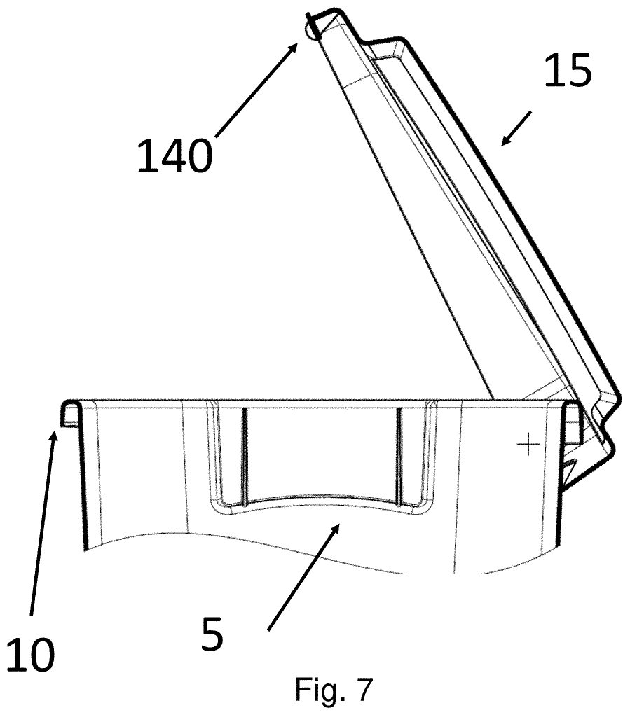

Referring to FIG. 6, there is shown a cross sectional view of trash receptacle 1 of the invention with lid closed. Latch 20 first latch part 140 is shown located on the bottom surface 101 of lid 15 at the proximal edge of lid 15 and the latch 20 first latch part 140 is shown being retained by rim 10 of can 5 (shown in FIG. 7) second latch part 141.

FIG. 7, shows a cross sectional view of trash receptacle 1 of the invention with lid open. Latch 20 first latch part 140 is shown located on the underside and on the proximal edge of lid 15 and the lid 15 is shown in the raised position.

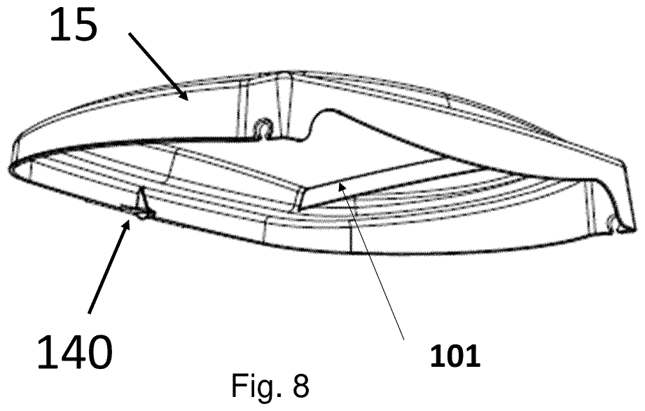

Referring to FIG. 8 there is shown an isometric view of the lid from the underside showing the latch 20 first latch part 140.

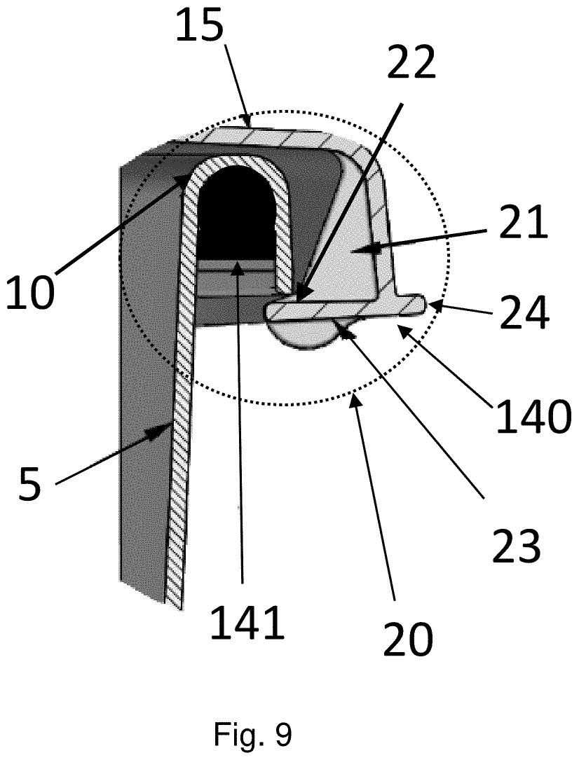

Referring to FIG. 9 there is shown a sectional view showing the can 5, latch 20 first latch part 140, latch 20 second latch part 141, lid 15 and can rim 10. Latch 20 first latch part 140 is formed as part of lid 15 during the molding process and the first latch part 140 comprises of lead-in ramp 22, snap hood 23, snap lip 24 and snap rib 21. Alternatively, second latch part 141 can be the lip/rim 10 with reinforcement or the lip/rim 10 without reinforcement.

The latch 20, first latch part 140, secures the lid 15 to the can rim 10, second latch part 141, through the following process. When the lid is being closed, lead-in ramp 22 of the latch 20 facilitates the displacement of the can lip/rim 10 during the closing of the lid 15 by rotatably deforming the can lip/rim 10 second latch part 141 as the lid 15 is closed. Alternatively, the latch 20 can be opened with one hand by the operator lifting on the snap lip 24 causing the snap hood 23 to rotatably deform, which releases the latch 20 first latch part 140 from the can lip 10 second latch part 141. The rotation can be either left to right or it can rotate away from the front 104 of the can 5. The first latch part 140 and said second latch part 141 being aligned.

The process of using the trash receptacle 1 comprised of can 5, lid 15 and a latch 20 by a person and the person having a first hand and a second hand. The lid 15 is rotatably mounted to the can 5 and the latch 20 having a first latch part 140 and said second latch part 141. The first latch part 140 and said second latch 141 part being aligned such that when first latch part is in communication with said second latch part, there is an interference and the person placing their first hand on the latch first latch part 140 to open the latch by applying force from the first hand to the first latch part 140 which removes the interference, such that the lid 15 can rotatably move by the person using only their first hand. The person's second hand is then free to remove a bag with the contents of the trash receptacle, without having to use their first hand.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A trash receptacle comprising of:
a. lower container portion, lid portion and a latch;
b. said lid portion having a top surface and a bottom surface;
c. said lower container portion comprised of a lower container portion opening, a bottom, a front, a back, a right side and a left side;
d. said lower container portion opening being the proximal end of said lower container portion and said bottom being distal from said lower container portion opening;
e. said lower container portion having a lip portion and said lip portion forming said lower container portion opening of said lower container portion;
f. said lower container portion, said right side having a right pin, and said right pin being mounted to said lower container portion, said right side proximal to said back of said lower container portion;
g. said lower container portion, said left side having a left pin, and said left pin being mounted to said lower container portion, said left side proximal to said back of said lower container portion;
h. said lid portion rotatably mounted to said lower container portion with a right padeye in communication with said right pin and a left padeye in communication with said left pin and said lid bottom being in communication with said lower container portion lip portion when said lid is closed;
i. said latch having a first latch part flexibly mounted to said lid bottom surface and distal from said right padeye and said left padeye;
j. said first latch part comprises of a lead-in ramp, a snap hood, a snap lip and a snap rib;
k. said latch having a second latch part mounted to said lower container portion lip and distal from said right pin and said left pin;
l. said first latch part and said second latch part being aligned; and
m. said first latch part and said second latch part having an interference between said first latch part and said second latch part when said lid is closed.

2. The trash receptacle of claim 1 wherein said lower container portion and said lid portion are made from material selected from the group consisting of fire-retardant plastic and thermoplastic material.

3. A trash receptacle for use by a person, and said person having a first hand and a second hand, said trash receptacle comprising of:
a. lower container portion, lid portion and a latch;
b. said lid portion having a top surface and a bottom surface;
c. said lower container portion comprised of a lower container portion opening, a bottom, a front, a back, a right side and a left side;
d. said lower container portion opening being the proximal end of said lower container portion, and said bottom being distal from said lower container portion opening;
e. said lower container portion having a lip portion and said lip portion forming said lower container portion opening of said lower container portion;
f. said lower container portion, said right side having a right pin, and said right pin being mounted to said lower container portion, said right side proximal to said back of said lower container portion;
g. said lower container portion, said left side having a left pin, and said left pin being mounted to said lower container portion, said left side proximal to said back of said lower container portion;
h. said lid portion rotatably mounted to said lower container portion with a right padeye in communication with said right pin, and with a left padeye in communication with said left pin, and said lid bottom being proximal to said lower container portion having a lip portion when said lid is closed;
i. said latch having a first latch part mounted to said lid bottom surface and distal from said right padeye and said left padeye;
j. said first latch part comprises of a lead-in ramp, a snap hood, a snap lip and a snap rib;
k. said second latch part is said lip portion;
l. said first latch part and said second latch part being aligned;
m. said first latch part being flexibly mounted to said lid bottom;
n. said first latch part and said second latch part having an interference between said first latch part and said second latch part;
o. said latch being positioned to open by said person applying force, using said first hand to said first latch part, which removes said interference between said lip portion and said first latch part, such that said lid portion can rotatably move about said right pin and said left pin, by said person using said first hand; and
p. said person, using said second hand, removes a bag with the contents of said receptacle, without having to use said first hand.

4. The trash receptacle of claim 3 wherein said lower container portion and said lid portion are made from material selected from the group consisting of fire-retardant plastic and thermoplastic material.

5. A process of using a trash receptacle comprised of a lower container portion, lid portion and a latch, and said latch has an interference between a first latch part and a second latch part by a person, and said person having a first hand and a second hand, said process comprising of:
a. said person placing said first hand on said first latch part to open said latch by applying force from said first hand to said first latch part which removes said interference between said first latch part and said second latch part such that said lid can rotatably move by said person using said first hand; and
b. said person second hand removes a bag with the contents of said receptacle, without having to use said first hand.
